(19) United States
(12) Patent Application Publication
(10) Pub. No.: US 2020/0324204 A1
(43) Pub. Date: Oct. 15, 2020

(54) AUTOMATIC GENERATION, PRESENTATION, DIAGRAMMING, AND INTERACTIVE EVALUATION OF LOGIC GAME-STYLE SCENARIOS

(71) Applicant: Mobile Intelligence Labs LLC, New York, NY (US)

(72) Inventor: Christopher M. ACKERMAN, New York, NY (US)

(21) Appl. No.: 16/844,731

(22) Filed: Apr. 9, 2020

Related U.S. Application Data
(60) Provisional application No. 62/831,563, filed on Apr. 9, 2019.

(51) Int. Cl. A63F 13/50; G06F 3/0484

(52) U.S. Cl. CPC A63F 13/50; G06F 3/0484

(57) ABSTRACT

Disclosed herein is a method of automatic generation, presentation, diagramming, and interactive evaluation of logic game-style scenarios. In some embodiments, the method includes displaying, on an electronic device, a graphical user interface (GUI) that includes a plurality of regions: a first region, a second region, a third region, and a fourth region. In some examples, the GUI is a logic game GUI; the logic game including a plurality of logic game questions associated with sets of rules.

### CROSS REFERENCE TO RELATED APPLICATION

This application claims the benefit under 35 U.S.C. § 119(e) of U.S. Provisional Patent Application No. 62/831,563, filed Apr. 9, 2019, the contents of which are incorporated herein by reference in their entireties for all purposes.

### FIELD

This disclosure relates generally to automatic generation, presentation, diagramming, and interactive evaluation of logic game-style scenarios and component elements on an electronic device and interactions with the electronic device.

### BACKGROUND

Standardized tests such as the LSAT include logic games as a part of the examination to gauge a test taker's logic skills. To prepare for such exams, the test taker typically enrolls in very expensive preparation courses that help the test taker to prepare efficiently, or purchases preparation books that require the test taker to figure out the exam on his or her own. As such, preparing and practicing for the logic portion of an examination can either be very expensive, very inefficient, or both. A test taker may desire a preparation method that is both inexpensive and efficient. Using an electronic device for such test preparation can be a solution because an electronic device is accessible to most test takers, and the electronic device can be configured to automatically generate practice questions and scenarios. An electronic device that automatically generates test preparation material may be desired.

### SUMMARY

Disclosed herein is a method of automatic generation, presentation, diagramming, and interactive evaluation of logic game-style scenarios. In some embodiments, the method includes displaying, on an electronic device, a graphical user interface (GUI) that includes a plurality of regions: a first region, a second region, a third region, and a fourth region. In some examples, the GUI is a logic game GUI; the logic game including a plurality of logic game questions associated with sets of rules. In some embodiments, the first region includes sets of graphical interface objects associated with elements of rules of a current logic game question. In some embodiments, the second region includes a manual input region where the user can provide manually create written input (e.g., hand sketch, hand written notes, etc.). In some embodiments, the second region presents an indication of a user's progress of the current question (e.g., a graphical indicator of determined relationship(s) of some of the elements). In some embodiments, the second region presents an automatically generated diagrammatic representation of logical rules or inferences. In some embodiments, the third region includes a current set of rules associated with a current set of logic game questions. In some embodiments, the fourth region includes user controls for interaction, navigation, or state management. In some embodiments, the third region includes a current question of the current set of logic game questions. In some embodiments, after the user completes a set of logic game questions, the first region includes indications of whether relationships of the elements determined by the user are correct. In some embodiments, after the user completes the set of logic game questions, the third region includes indications of whether answers provided by the user are correct. In some embodiments, the third region includes automatically generated explanations or illustrations of inferences or answers.

### BRIEF DESCRIPTION OF THE DRAWINGS

FIG. 1 illustrates a logic gaming GUI according to examples of the disclosure.

FIG. 2 illustrates a logic gaming GUI according to examples of the disclosure.

FIG. 3 illustrates a logic gaming GUI according to examples of the disclosure.

FIG. 4 illustrates a logic gaming GUI according to examples of the disclosure.

FIG. 5 illustrates a logic gaming GUI according to examples of the disclosure.

FIG. 6 illustrates an exemplary method of playing an automatically generated logic game according to examples of the disclosure.

FIG. 7 illustrates a logic gaming GUI according to examples of the disclosure.

### DETAILED DESCRIPTION

In the following description of examples, reference is made to the accompanying drawings in which it is shown by way of illustration specific examples that can be practiced. It is to be understood that other examples can be used and structural changes can be made without departing from the scope of the various examples.

Disclosed herein is a method of automatic generation, presentation, diagramming, and interactive evaluation of logic game-style scenarios. In some embodiments, the method includes displaying, on an electronic device, a graphical user interface (GUI) that includes a plurality of regions: a first region, a second region, a third region, and a fourth region. In some examples, the GUI is a logic game GUI; the logic game including a plurality of logic game questions associated with sets of rules. In some embodiments, the first region includes sets of graphical interface objects associated with elements of rules of a current logic game question. In some embodiments, the second region includes a manual input region where the user can provide manually create written input (e.g., hand sketch, hand written notes, etc.). In some embodiments, the second region presents an indication of a user's progress of the current question (e.g., a graphical indicator of determined relationship(s) of some of the elements). In some embodiments, the second region presents an automatically generated diagrammatic representation of logical rules or inferences. In some embodiments, the third region includes a current set of rules associated with a current set of logic game questions. In some embodiments, the fourth region includes user controls for interaction, navigation, or state management. In some embodiments, the third region includes a current question of the current set of logic game questions. In some embodiments, after the user completes a set of logic game questions, the first region includes indications of whether relationships of the elements determined by the user are correct. In some embodiments, after the user completes the set of logic game questions, the third region includes indications of whether answers provided by the user are correct. In some embodiments, the third region includes automatically generated explanations or illustrations of inferences or answers.

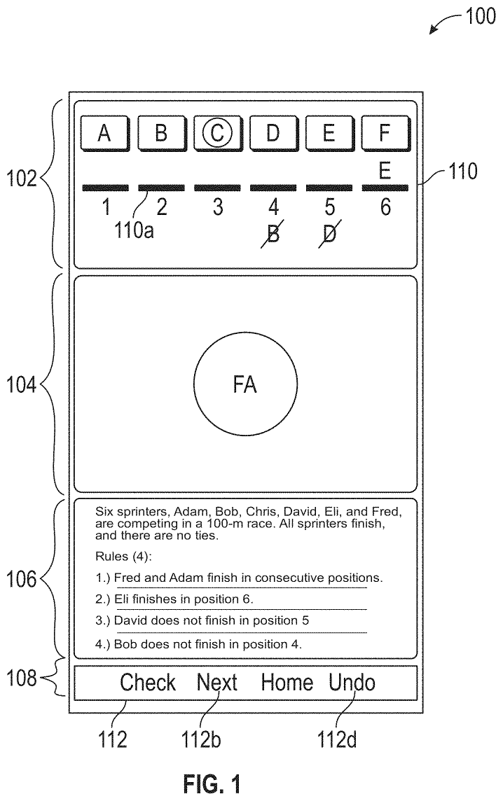

FIG. 1 illustrates a logic gaming GUI according to examples of the disclosure. In some embodiments, a logic game is presented on an electronic device (e.g., a phone, a tablet, a computer). In some embodiments, the electronic device accepts input from a touch object (e.g., finger, stylus). The logic game includes a GUI 100. As illustrated, the GUI 100 includes a first region 102, a second region 104, a third region 106, and a fourth region 108. In some embodiments, the GUI 100 is displayed after a selection of a particular logic game scenario from a main menu GUI, which will be described below.

In some embodiments, the first region 102 includes a first set of interactive user interface (UI) objects. For example, the first region 102 includes first sets of interactive UI objects 110. In some embodiments, the first sets of interactive UI objects 110 include interactive UI objects that are associated with the elements of a set of rules associated with a current set of logic game questions. For example, the set of rules determine finishing position of runners: Adam, Bob, Chris, David, Eli, and Fred; the first sets of interactive UI objects 110 may be graphics that include the letters “A,” “B,” “C,” “D,” etc.

In some embodiments, one or more of: a verbal description of a logic game-style scenario, a set of rules, a set of logic game questions, their respective elements, and the answers corresponding to the questions are automatically generated by the electronic device. For example, to keep the user engaged, the electronic device can automatically generate different scenarios (e.g., elements other than runners and finishing positions) under a similar set of rules. In some embodiments, the complexity of the automatically generated rules and questions is defined by the user. In some embodiments, core components of logic game-style problems, such as entailment, negation, and rewordings are automatically generated, presented, and evaluated.

In some embodiments, two or more electronic devices can present the same set of rules or the same question at the same time. For example, two or more users are practicing the same questions together on their respective devices. In some embodiments, information (e.g., answer explanations, contents of a particular logic game/set of rules) associated with a first user's logic game may be shared with a second user.

In some embodiments, the first sets of interactive UI objects 110 include a set of positions associated with the elements. For example, the set of rules determines the finishing positions of the runners. In addition to graphics that include the letters “A,” “B,” “C,” “D,” etc. (e.g., corresponding to the names of the racers), the first sets of interactive UI objects 110 can also include slots 110A associated with finishing positions (e.g., 1^{st}, 2^{nd}, 3^{rd}, etc.).

In some embodiments, the first sets of UI elements 110 can be dragged and dropped in response to touch inputs to the electronic device. For example, if the user determines that Eli finished 6^{th}, the user can provide a touch input to move the graphical interface object “E” from at least one object 110 to the interactive UI object associated with the 6^{th} position.

In some embodiments, the first region 102 can include determined relationships of the elements. For example, if the user determines that Bob cannot finish 4^{th} and David cannot finish 5^{th}, representations (e.g., crossed out B under 4^{th} place, crossed out D under 5^{th} place) of Bob and David indicate that they cannot finish 4^{th} and 5^{th}, respectively (e.g., in accordance with a determination by the electronic device, or in response to receiving an input (e.g., swipe input) from the user).

In some embodiments, the second region 104 is a region that accepts manual input. For example, the user can write freely on the second region 104 using a touch object. In some embodiments, a user can drag and drop one or more of the interactive UI objects 110 into the second region 104 and manually input annotations in the second region 104 to work through the set of rules. In some embodiments, in addition to accepting a manual input, the second region 104 is caused to display an automatically generated inference diagram. The second region 104 may be automatically expanded or contracted in response to device rotation, to allow more space for user input.

In some embodiments, the third region 106 includes rules associated with a current logic game question of the logic game. In this instance, the rules are a set of logical relationship between the elements (e.g., the runners). Based on the rules, the user can deduce the exact relationship between elements in the current logic game scenario. For example, the rules can lead the user to figure out a finishing position for a particular runner.

In some embodiments, the third region 106 cannot exceed a maximum size. For example, the third region 106 cannot exceed one-third of the region of the GUI 100. In some instances, the text (e.g., the rules, the question) associated with third region 106 may be too large to be displayed entirely. In some embodiments, in response to a determination that the texts cannot be displayed entirely within a maximum region of the third region, portions of the texts are made scrollable within the third region.

In some embodiments, in response to a determination a rule has been addressed, the third region 106 may be updated (by the user or automatically) to indicate (e.g., by crossing out corresponding text (not shown)) that the rule has been addressed.

In some embodiments, in response to receiving a user request, the first and/or second regions are updated to illustrate automatically generated diagrams and notations of automatically identified rules or inferences. In some embodiments, the user-generated diagrams are automatically annotated or highlighted to illustrate correct or incorrect portions. In some embodiments, in response to receiving a user request, the second and/or third region is updated to include verbal or visual explanations of inferences, in terms of rule attributions or allowed or forbidden element mappings. In some embodiments, the user may alternate between views of regions 102, 104, or 106 via, e.g., swiping or keypress.

In some embodiments, the fourth region 108 includes second sets of interactive UI objects 112. In some embodiments, the fourth region includes user controls for interaction, navigation, or state management. Selection (e.g., via a touch input) of the interactive UI objects 112 can cause the electronic device to display a different GUI. For example, selection of interactive UI object 112b causes the electronic device to display a next logic game logic game question. As another example, selection of interactive UI object 112d undoes a user's input onto the GUI 100 (e.g., erases an input to the second region 104, deselect a selection of one of the first sets of interactive UI objects 110).

In some embodiments, the first to fourth regions occupy different portions of a display for different logic game questions. For example, the size of the first region 102 depends on the number of the first sets of interactive UI objects 110. As another example, a logic game question having a greater number of elements would occupy a larger first region 102 than a logic game question having a smaller number of elements. As yet another example, a logic game question requiring matching of elements to positions would occupy a larger first region 102 than a logic game question requiring ordering of elements and not matching to positions. In some examples, depending on the length of the current logic game question or rules, the third region 106 occupies a region of the display that accommodates all the texts associated with the logic game question or the rules.

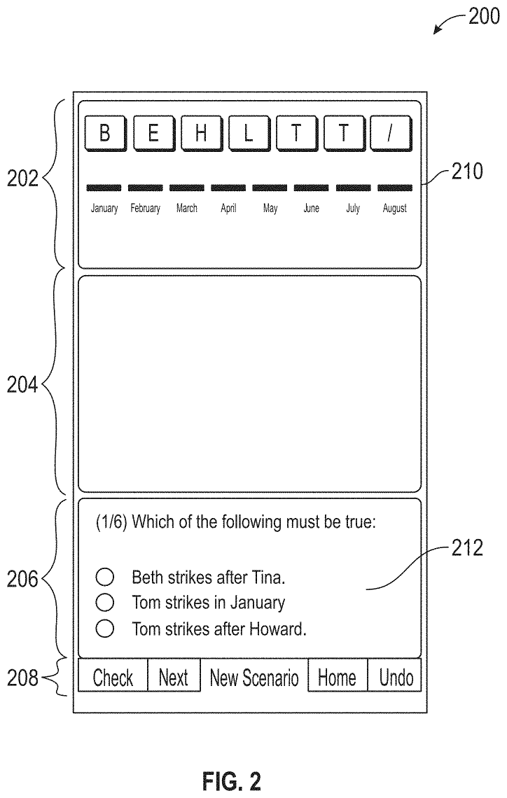

FIG. 2 illustrates a logic gaming GUI according to examples of the disclosure. The logic game includes a GUI 200. As illustrated, the GUI 200 includes a first region 202, a second region 204, a third region 206, and a fourth region 208. The first region 202, the second region 204, the third region 206, and the fourth region 208 can have one or more functionalities, one or more configurations, or both, that are corresponding similar to the first region 102, the second region 104, the third region 106, and the fourth region 108. In this example, the GUI 200 displays a question about occurrences of hurricanes in particular months.

In some embodiments, the GUI 200 is presented in response to a determination of relationships between elements of a current set of rules. As illustrated, the third region 206 includes a logic game question about the determined relationships. In some embodiments, the logic game question is presented when the logic game is in the logic game question mode. For example, in the logic game question mode, after a user figures out the relationship between the hurricanes and their months of occurrences, the third region 206 is updated to display a logic game question about the relationship (e.g., “Which of the following must be true:”). In some embodiments, a user can provide an additional input confirming the determination before the third region 206 is updated to present a logic game question (e.g., the user is sure about the relationships that he or she determined.). As illustrated, the third region 206 also includes answer choices 212. In some embodiments, in response to a selection of one of the answer choices 212, the third region 206 is updated to display a next logic game question.

In some embodiments, the user has the option to return to the logic game question or the rules. In some embodiments, in response to receiving a swiping input, the logic gaming GUI is updated to display a previous logic game question or rules. In some embodiments, in response to a request to return to the logic game question or the rules, the electronic device updates the display of the third region 206 to present the logic game question or the rules.

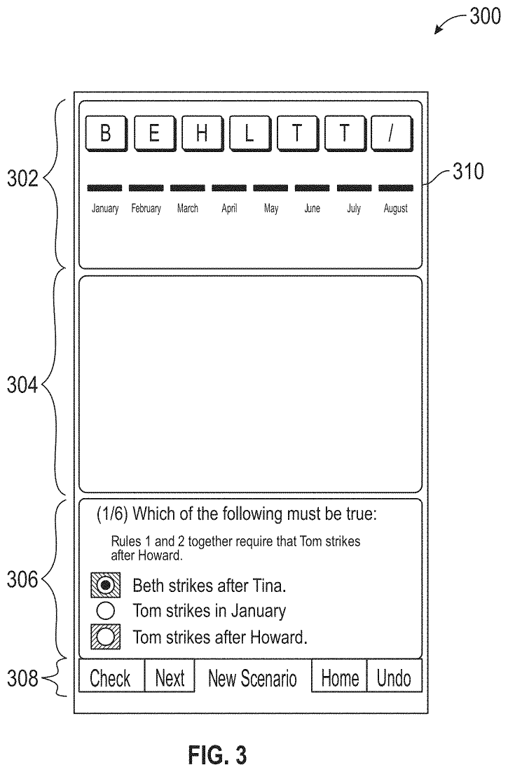

FIG. 3 illustrates a logic gaming GUI according to examples of the disclosure. The logic game includes a GUI 300. As illustrated, the GUI 300 includes a first region 302, a second region 304, a third region 306, and a fourth region 308. The first region 302, the second region 304, the third region 306, and the fourth region 308 can have one or more functionalities, one or more configurations, or both, that are corresponding similar to the first region 102 (or 202), the second region 104 (or 204), the third region 106 (or 206), and the fourth region 108 (or 208).

In some embodiments, the GUI 300 is presented in response to completing one or more logic game questions. In some embodiments, the GUI 300 is presented after the user answers the current logic game question. As illustrated, the third region 306 includes a logic game question that the user answered (e.g., from touch input received when GUI 200 was displayed) and the user's answer. In some embodiments, in response to a determination that the user had answered the logic game question correctly, the user's answer choice is presented in a first manner (e.g., shaded or highlighted in a first color). In some embodiments, in response to a determination that the user answered the logic game question incorrectly, the user's answer choice is indicated in a second manner (e.g., highlighted in a second color) and the correct answer choice is indicated in the first manner. In some embodiments, in response to a determination that the user answered the logic game question incorrectly, an explanation (e.g., in terms of rule attributions or allowed or forbidden element mappings) and/or feedback is presented in the third region 306. In some embodiments, the explanation and/or feedback is automatically generated by the electronic device to correspond with the automatically generated scenario.

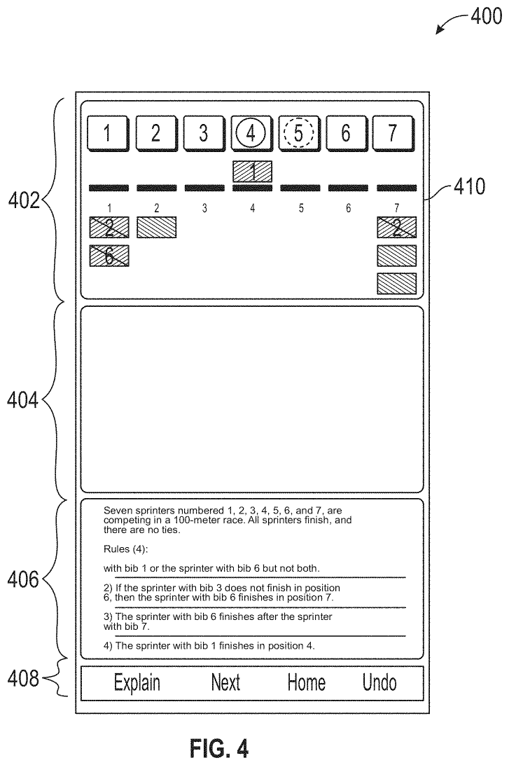

FIG. 4 illustrates a logic gaming GUI according to examples of the disclosure. For brevity, the different regions of GUI 400 will not be described again. In some embodiments, the third region 406 includes a set of rules associated with logic game questions that the user answered. In this example, the user's determination of the relationship between the elements was incorrect. As illustrated, the user's determination that sprinter 2 did not finish in the 1^{st} or 7^{th} position is correct (e.g., the crossed out 2's are highlighted in a color), and the user is missing inferences associated with the 2^{nd} and 7^{th} position (e.g., indicated with empty shaded boxes under the 2^{nd} and 7^{th} positions).

In some embodiments, in response to a determination that the user correctly determined a relationship of an element (e.g., an element is in a correct position), the element is presented in a first manner (e.g., highlighted in a first color, such as green). In some embodiments, in response to a determination that the user had incorrectly determined the relationship between the elements, the element is presented in a second manner (e.g., highlighted in a second color, such as red).

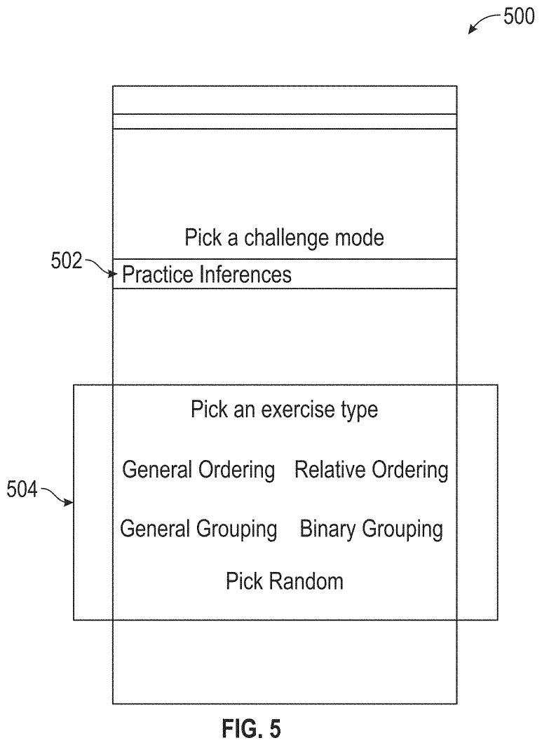

FIG. 5 illustrates a logic gaming GUI according to examples of the disclosure. In some embodiments, GUI 500 is a main menu of the logic game. For example, the main menu is presented in response to an input to launch a logic game application on the electronic device.

As illustrated, the GUI 500 includes a mode selection interactive UI object 502 and question type interactive UI objects 504. In some embodiments, selection of the interactive UI object 502 causes the electronic device to present to the user a list of game mode options. For example, the game mode options include “practice inferences” and “practice questions”.

In some embodiments, selection of one of the question type interactive UI objects 504 causes the electronic device to present the GUI 100. For example, the question types include “general ordering,” “relative ordering,” “general grouping,” “binary grouping,” and “pick random.” It is understood that other game modes and question types exist without departing from the scope of the disclosure.

In some embodiments, the content in each region of the disclosed GUI is based on the selected mode and/or the selected question type. In some embodiments, in response to a selection of the “practice inferences” mode on the main menu, the GUI 100 is presented on the electronic device. After the user determines the relationship between the elements and their relationships, GUI 400 is shown to indicate whether the determined relationships are correct.

In some embodiments, in response to a selection of the “practice questions” mode, the GUI 100 is presented on the electronic device. After the user determines the relationship between the elements and their relationships, GUI 300 is shown to display logic game questions associated with the set of rules presented in GUI 100.

In some embodiments, the size of each region of the disclosed GUI is based on the selected mode and/or the selected question type. For example, in response to a selection of “general ordering” question type on the main menu, the electronic device is caused to display: a first region that includes sets of interactive UI objects corresponding to elements of the question and possible positions and a third region including text associated with a current set of rules of a current logic game or a current logic game question. In some embodiments, the size of the second region is determined by the size of the first region and size of the third region (e.g., the second region occupies the remaining region of the display).

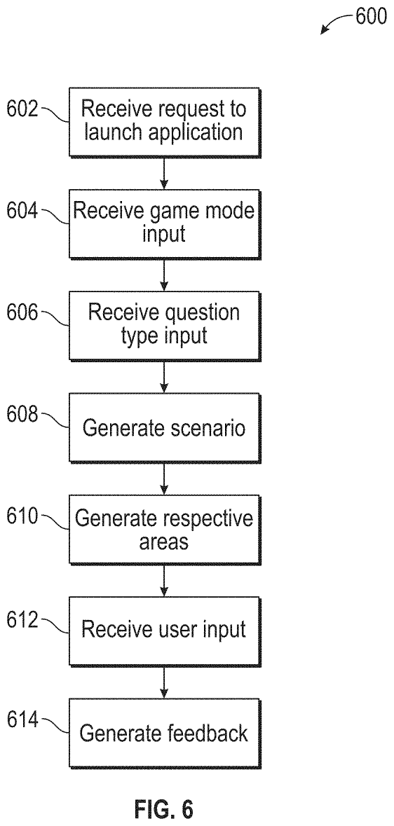

FIG. 6 illustrates an exemplary method 600 of playing an automatically generated logic game according to examples of the disclosure. The method 600 includes receiving, at an electronic device, a request to launch the logic game application (step 602). For example, a user launches the logic game application on his or her phone.

The method 600 includes receiving, at the electronic device, an input indicating selection of a game mode (step 604). For example, the user selects one of the game modes, as described with respect to FIG. 5.

The method 600 includes receiving, at the electronic device, an input indicating selection of a question type (step 606). For example, the user selects one of the question types, as described with respect to FIG. 5.

The method 600 includes, in response to receiving the inputs indicating selections of the game mode and the question type, generating, by the electronic device, a logic game scenario based on the selected game mode and question type (step 608). For example, the user selected “practice question” mode and “general ordering” question type, and a logic game scenario is generated based on user input, as described with respect to FIGS. 1-5.

The method 600 includes, in response to generating the logic game scenario, generating, by the electronic device, a first region, a second region, and a third region of a GUI based on the generated logic game scenario (step 610). For example, the logic game scenario is generated based on the user's selection of “practice question” mode and “general ordering” question type, and in response to the generation, the interactive UI objects and texts on the GUI are generated based on the generated logic game scenario (e.g., interactive UI objects associated with hurricane names and months, the set of rules associated with the hurricanes, a current question associated with a relationship between the hurricanes), as described with respect to FIGS. 1-5.

The method 600 includes receiving, at the electronic device, input from the user on one or more of the first region, second region, and the third region (step 612). For example, the user drags and drops an interactive UI object associated with a hurricane to an interactive UI object associated with a particular month, as described with respect to FIGS. 1-5. As another example, the user inputs, by hand, on the second region an inference diagram associated with the set of rules. As yet another example, the user selects an answer on the third region.

The method 600 includes generating, by the electronic device, feedback associated with the user's input to the one or more of the first region, second region, and third region of the GUI (step 614). For example, after the user finishes an interference practice or a practice question, the electronic device generates feedback (e.g., right/wrong answers, explanations) based on the user's answers and the GUI is updated to indicate the feedback to the user, as described with respect to FIGS. 1-5.

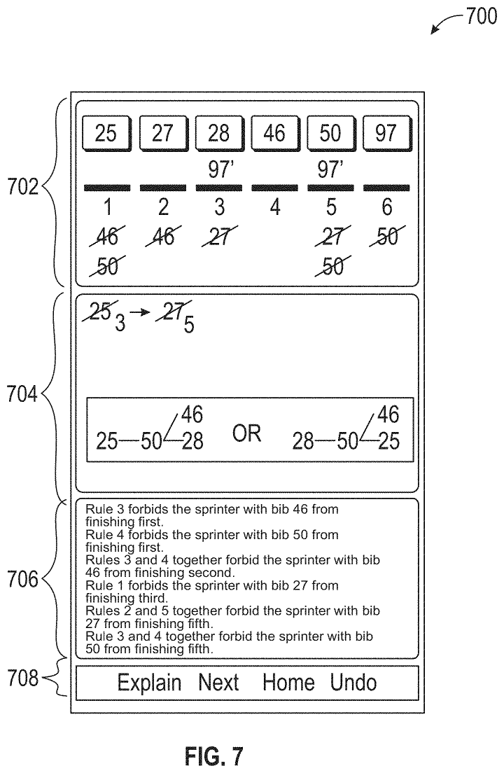

In some embodiments, the method 600 includes automatically generating logic game-style scenarios and/or rule sets, as described with respect to FIG. 7 below. In some embodiments, the scenarios and/or rules are automatically generated based on one or more of: 1) a model of the problem-generating process that is based on establishing correspondences between sets, 2) a representation of the complete problem space computed through recursive functions that generate all permutations of the set combinations, and 3) a series of compatible, parameterized constraints that are applied to the problem space.

In some embodiments, the method 600 includes automatically generating verbal descriptions of logic game-style scenarios and/or rule sets. In some embodiments, the scenarios correspond to real-world phenomena whose structure matches the set correspondences that comprise a given game scenario. In some embodiments, the scenarios include groups of names for members of the sets. In some embodiments, an electronic device performs an algorithm for incorporating the groups of names into the scenarios.

In some embodiments, the method 600 includes automatically generating inference diagrams. In some embodiments, the diagrams include ordering lines, trees, groupings, and logical connectors.

In some embodiments, the method 600 includes automatically evaluating user-generated inference diagrams. In some embodiments, a user inputs symbols within a structure, the symbols are compared to an automatically generated model, and in accordance with a determination of whether the symbols are correct, the elements are labeled as correct or incorrect.

In some embodiments, the method 600 includes automatically generating and presenting explanation of logical inferences. In some embodiments, the explanations are based on recursively applying combinations of the rules and/or constraints to a parameter space and inferences can be attributed to a minimal set of rules/constraints required to cause the combinations.

In some embodiments, the method 600 includes automatically generating logic game-style questions and evaluating answers. In some embodiments, the method includes exploring the constraint space and based on the exploring, generating possible constraints, determining impossible constraints, and determining set-mapping combinations.

In some embodiments, the method 600 includes automatically explaining correct and incorrect answers. In some embodiments, the answers are based on the constraints and set-correspondences, which lead to particular inferences that are computed to arrive at the answers. In some embodiments, the answers are presented on the GUI.

In some embodiments, the method 600 includes automatically rating the difficulty level of logic game-style scenarios/rule sets. In some embodiments, the method includes automatically rating the difficulty level of logic game-style questions. In some embodiments, the method includes automatically generating logical inference practice exercises. In some embodiments, the method includes sharing the games with a second user.

Automatically/algorithmically generated components may be produced locally on the user's electronic device, or remotely on a different electronic device and downloaded or installed from a cloud server onto the user's device. They may be produced—either locally or remotely—dynamically in response to real-time user input or statically in advance and accessed as needed.

In some embodiments, the method includes one or more of: (1) serializing, deserializing, saving data locally, and exchanging the data with server, (2) sequencing scenario and/or question types, and (3) keeping score and/or time the game.

FIG. 7 illustrates a logic gaming GUI according to examples of the disclosure. For brevity, the different regions of GUI 700 will not be described again. In some embodiments, the first region 702 and/or the second region 704 includes an automatically generated rule and/or inference diagram. In some embodiments, the rules are automatically generated by the electronic device. In some embodiments, in response to the automatic generation of the rules, an inference diagram is automatically generated by the electronic device. In some embodiments, the inference diagram reflects the constraints governed by the automatically generated rules. The diagrams may include ordering lines, annotated labels, trees, logical connectors, or groupings, inter alia. In some embodiments, the user may compare their diagrams with those generated automatically by swiping back and forth on region 702 or 704. In some embodiments, the third region 706 may be updated to include verbal explanations of inferences or answers. In some embodiments, the user may swipe back and forth on region 706 to alternate between viewing the rules and the explanations.

Various functions described above can be implemented in electronic circuit, in computer software, firmware, or hardware. The techniques can be implemented using one or more computer program products. Programmable processors and computers can be included in or packaged as mobile devices. The processes and logic flows can be performed by one or more programmable processors and by one or more programmable logic circuit. General and special purpose computer devices and storage devices can be interconnected through communication networks.

Some implementations include electronic components, such as microprocessors, storage, and memory that can store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, ultra-density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer,” processor,” and “memory” all refer to electronic or other technological devices. These terms exclude people or groups of people. For the purposes of the specification, the terms “display” or “displaying” means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device described herein for displaying information to the user and a virtual or physical keyboard and a pointing device, such as a finger, pencil, mouse or a trackball, by which the user can provide input to the computer. Other kinds of devices can be used to provide for interaction with a user as well; for example, feedback provided to the user can be any form of sensory feedback, such as visual feedback, auditory feedback, or tactile feedback; and input from the user can be received in any form, including acoustic, speed, or tactile input.

Many of the above-described features and applications are implemented as software processes that are specified as a set of instructions recorded on a computer readable storage medium (also referred to as a computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a standalone program or as a module, component, or subroutine, object, or other component suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms or portions of code). A computer program can be deployed to be executed on one computer or on multiple computers that are located at one site or distributed across multiple sites and interconnected by a communication network.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Some of the blocks may be performed simultaneously. For example, in some instances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein the reference to an element in the singular is not intended to mean “one and only one” unless specifically so stated, but rather “one or more.” Unless specifically stated otherwise, the term “some” refers to one or more. Headings and subheadings, if any, are used for convenience only and do not limit the subject disclosure.

The predicate words “configured to,” “operable to,” “capable of,” and “programmed to” do not imply any particular tangible or intangible modification of a subject, but, rather, are intended to be used interchangeably. For example, a processor configured to monitor and control an operation or a component may also mean the processor being programmed to monitor and control the operation, or the processor being operable to monitor and control the operation. Likewise, a processor configured to execute code can be construed as a processor programmed to execute code or operable to execute code.

The word “example” is used herein to mean “serving as an example or illustration.” Any aspect or design described herein as “example” is not necessarily to be construed as preferred or advantageous over other aspects or designs.

Although examples have been fully described with reference to the accompanying drawings, it is to be noted that various changes and modifications will become apparent to those skilled in the art. Such changes and modifications are to be understood as being included within the scope of the various examples as defined by the appended claims.

We claim:

1. A method comprising:
at an electronic device comprising a display and one or more processors and memory:
receiving, at the electronic device, a request to launch a logic game application;
receiving, at the electronic device, an input indicating selection of a game mode of the logic game application;
receiving, at the electronic device, an input indicating selection of a question type;
in response to receiving the inputs indicating selections of the game mode and the question type, generating, by the electronic device, a logic game scenario based on the selected game mode and question type; and
in response to generating the logic game scenario, generating, by the electronic device, a first region, a second region, and a third region of a graphical user interface (GUI) based on the generated logic game scenario on the display.

2. The method of claim 1, wherein generating the logic game scenario further comprises generating, at the electronic device, at least one of:
a verbal description of the logic game scenario,
a set of rules associated with the logic game scenario,
a set of logic game questions, GUI elements associated with the logic game scenario, and an answers corresponding to the set of logic game questions.

3. The method of claim 1, wherein the first region of the GUI includes at least one of:
sets of graphical interface objects associated with elements of rules of a current logic game question, and
indications of whether relationships of elements set by the user are correct.

4. The method of claim 3, wherein the sets of graphical interface objects include a set of movable graphical interface objects, the method further comprising:
displaying, on the display, an element of the set of movable graphical interface object at a first location of the first region;
receiving, at the electronic device, input from the user associated with moving the element from the first location of the first region to a second position of the first region; and
in response to the input from the user moving the element, updating, by the electronic device, the display to present the element at the second location of the first region.

5. The method of claim 3, further comprising:
receiving, at the electronic device, input from the user on the first region of the GUI setting relationships of elements of the logic game scenario;
determining, by the electronic device, whether the input is associated with a correct relationship of the logic game scenario; and
updating, by the electronic device, the first region of the GUI to present the indications of whether the relationships of elements set by the user are correct.

6. The method of claim 1, wherein the second region of the GUI includes at least one of:
a manual input region,
an indication of progress of a current question of the logic game scenario, and
a diagrammatic representation of logic rules or interferences generated by the electronic device.

7. The method of claim 6, wherein the second region of the GUI includes the manual input region, the method further comprising:
receiving, at the electronic device, hand-written input from the user on the manual input region; and
updating, by the electronic device, the display to present graphical interface objects associated with the hand-written input on the second region of the GUI.

8. The method of claim 1, wherein the third region of the GUI includes at least one of:
a current set of rules associated with the logic game scenario,
a current question of the logic game scenario,
indications of whether answers to questions of the logic game scenario provided by a user are correct, and
explanations or illustrations of inferences or answers to the questions of the logic game scenario generated by the electronic device.

9. The method of claim 8, wherein:
the third region includes the current question of the logic game scenario, and
the current question includes a plurality of answer choices, the method further comprising:
receiving, at the electronic device, input from the user on the third region selecting one of the answer choices,
updating, by the electronic device, the display to present an indication of the selected answer choice.

10. The method of claim 9, further comprising:
determining, by the electronic device, whether the selected answer is correct;
in accordance with a determination that the selected answer is correct, updating, by the electronic device, the display to replace the indication of the selected answer choice with an indication that the selected answer is correct, and
in accordance with a determination that the selected answer is not correct, updating, by the electronic device, the display to present an indication of a correct answer of the answer choices, different from the selected answer.

11. The method of claim 1, further comprising determining, by the electronic device, areas of the first, second, and third regions of the GUI based on displayed content associated with the first, second, and third regions of the GUI.

12. The method of claim 1, further comprising in response to generating the logic game scenario, generating a fourth region of the GUI on the display, wherein the fourth region includes GUI elements associated with user controls for at least one of interaction, navigation, and state management.

13. The method of claim 12, further comprising:
receiving, at the electronic device, input from the user on an element of the GUI elements of the fourth region, the action associated with an action to the logic game scenario; and
in response to receiving the input from the user on the element of the GUI elements of the fourth region, updating, by the electronic device, the display of at least one of the first region, the second region, and the third region representing the action to the logic game scenario.

14. The method of claim 1, further comprising:
receiving, at the electronic device, input from the user on at least one of the first region, second region, and the third region of the GUI; and
generating, by the electronic device, feedback associated with the user's input to the at least one of the first region, second region, and third region of the GUI.

15. The method of claim 14, wherein:
the input from the user on the at least one of the first region, second region, and the third region of the GUI is associated with an answer of a question of the logic game scenario determined by the user, and
the feedback is at least one of an indication of whether the answer of the question determined by the user is correct and an explanation of a correct answer of the question.

16. The method of claim 1, wherein the game mode is one of interferences and multiple choice questions.

17. The method of claim 1, wherein the question type is one of general ordering, relative ordering, general grouping, and binary grouping.

18. The method of claim 1, further comprising:
at a second electronic device comprising a second display and one or more second processors and memory:
in response to generating the logic game scenario, generating, by the second electronic device, the first region, the second region, and the third region of the graphical user interface (GUI) based on the generated logic game scenario on the second display.

19. An electronic device, comprising:
one or more processors;
memory; and
one or more programs, wherein the one or more programs are stored in the memory and configured to be executed by the one or more processors, the one or more programs including instructions for:
receiving a request to launch a logic game application;
receiving an input indicating selection of a game mode of the logic game application;
receiving an input indicating selection of a question type;
in response to receiving the inputs indicating selections of the game mode and the question type, generating a logic game scenario based on the selected game mode and question type; and
in response to generating the logic game scenario, generating a first region, a second region, and a third region of a graphical user interface (GUI) based on the generated logic game scenario on the display.

20. A non-transitory computer readable storage medium storing one or more programs, the one or more programs comprising instructions, which when executed by an electronic device with one or more processors and memory, cause the device to:
receive, at the electronic device, a request to launch a logic game application;
receive, at the electronic device, an input indicating selection of a game mode of the logic game application;
receive, at the electronic device, an input indicating selection of a question type;
in response to receiving the inputs indicating selections of the game mode and the question type, generate, by the electronic device, a logic game scenario based on the selected game mode and question type; and
in response to generating the logic game scenario, generate, by the electronic device, a first region, a second region, and a third region of a graphical user interface (GUI) based on the generated logic game scenario on the display.
